(19) United States
(12) Patent Application Publication
(10) Pub. No.: US 2020/0220948 A1
(43) Pub. Date: Jul. 9, 2020

(54) UNIQUE ID FOR CORRELATING SERVICES ACROSS REGIONS

(71) Applicant: Byton North America Corporation, Santa Clara, CA (US)

(72) Inventors: EVAN STALTER, Santa Clara, CA (US); JOSEPH SWAGER, Santa Clara, CA (US)

(21) Appl. No.: 16/240,664

(22) Filed: Jan. 4, 2019

(51) Int. Cl. H04L 29/08; B60W 50/08; G06F 21/62; G06F 21/32; H04W 4/40

(52) U.S. Cl. CPC H04L 67/34; H04L 67/306; H04W 4/40; G06F 21/6254; G06F 21/32; B60W 50/08

(57) ABSTRACT

Systems and methods for correlating services are described. For one embodiment, a number of cloud environments located in different regions to provide a platform-based single sign-on (SSO), with each cloud environment hosting a same set of cloud services. A unique identifier (ID) can be created for a user based on a profile of the user. The unique ID can be used to correlate the cloud services within each cloud environment and across the cloud environments in the different regions. The unique ID can be used to download the user's preference data to a vehicle that the user is to drive in each of the regions so that the user can drive the vehicle with a set of desired driving settings and infotainment applications. The unique ID of a user and preference data of the user can be anonymized using one or more security protocols.

### FIELD

Embodiments of the present disclosure are generally related to cloud services, and are particularly related to using unique identifiers to correlate services across multiple regions.

### BACKGROUND

In an increasingly interconnected world, a corporation may have multiple interrelated systems. For example, a vehicle manufacturer may have a computing system in each vehicle it manufactured, an information system for vehicle-related services, and an information system for peer-to-peer interactions for its customers. A user or potential user of a corporation's products may need to access each system from multiple regions. Therefore, it would be desirable to provide a platform for correlating services in each system for a user, and to enable the user to access the services using a single login identifier from multiple regions.

### SUMMARY

Systems and methods for correlating services are described. For one embodiment, a number of cloud environments located in different regions to provide a platform-based single sign-on (SSO), with each cloud environment hosting a same set of cloud services. A unique identifier (ID) can be created for a user based on a profile of the user. The unique ID can be used to correlate the cloud services within each cloud environment and across the cloud environments in the different regions. The unique ID can be used to download the user's preference data to a vehicle that the user is to drive in each of the regions so that the user can drive the vehicle with a set of desired driving settings and infotainment applications. The unique ID of a user and preference data of the user can be anonymized using one or more security protocols.

### BRIEF DESCRIPTION OF THE DRAWINGS

The figures of the accompanying drawings provide examples of embodiments. Like references indicate similar elements.

FIG. 1 illustrates an example system for correlating services from multiple regions in accordance with an embodiment.

FIG. 2 illustrates another example system for correlating services in accordance with an embodiment.

FIG. 3 illustrates an example environment where a user's preference data can be displayed in accordance with an embodiment.

FIG. 4 illustrates another example system for correlating services in accordance with an embodiment.

FIG. 5 illustrates example cloud services in a cloud environment in accordance with an embodiment.

FIGS. 6A-6D illustrate example user interfaces of a mobile application in accordance with an embodiment.

FIG. 7 is a flow diagram of one example method for correlating services across regions in accordance with an embodiment.

### DETAILED DESCRIPTION

The systems and methods for using a unique identifier (ID) to correlate services from multiple regions are described below. In particular, the unique ID enables access to a same set of services either from a vehicle or from a smart phone from multiple different regions. As used herein, a vehicle can be a road vehicle, such as an automobile, a van, a truck, and a bus; a train; an aircraft, such as an airplane; a spacecraft; or any machinery that transports people or things.

In the specification, reference “one embodiment” or “an embodiment” means that a particular feature, structure, or characteristic described in conjunction with the embodiment can be included in at least one embodiment. The appearances of the phrases “in one embodiment” or “for one embodiment” in various places in the specification do not necessarily all refer to the same embodiment.

Systems and methods for correlating services are described. For one embodiment, a number of cloud environments located in different regions to provide a platform-based single sign-on (SSO), with each cloud environment hosting a same set of cloud services. A unique identifier (ID) can be created for a user based on a profile of the user. The unique ID can be used to correlate the cloud services within each cloud environment and across the cloud environments in the different regions. The unique ID can be used to download the user's preference data to a vehicle that the user is to drive in each of the regions so that the user can drive the vehicle with a set of desired driving settings and infotainment applications. The unique ID of a user and preference data of the user can be anonymized using one or more security protocols.

For one embodiment, a system for correlating services includes a plurality of cloud environments located in a plurality of regions, each of the plurality of cloud environments hosting a same set of cloud services. The plurality of cloud environments are managed by a central cloud manager. The system further includes a unique ID based on a profile of a user that has been registered with the central cloud manager. The unique ID enables access to the same set of cloud services from each of the plurality of regions.

For one embodiment, a method for correlating services includes hosting a same set of cloud services on each of a plurality of cloud environments located in a plurality of regions. The plurality of cloud environments are managed by a central cloud manager. The method includes generating a unique ID based on a profile of a user that has been registered with the central cloud manager. The method includes accessing the same set of cloud services from each of the plurality of regions using the unique ID.

For one embodiment, the same set of cloud services and contents they provide are localized by region. The cloud environments are connected to multiple configuration databases that are synchronized with one another. Each region can be a country or a group of countries. The unique ID can be generated using a predetermined algorithm based on the user's profile, and can be used to correlate services from multiple regions and to correlate multiple systems in the multiple regions. At least one cloud service is configured to provide preference data of a user. For one embodiment, the preference data specifies a set of desired driving settings and a set of desired infotainment applications for the user when driving a vehicle.

For one embodiment, the user can log in to a cloud environment in a particular region using biometric recognition in a vehicle, and if the biometric recognition fails, can use a mobile application and the unique ID to log in to the cloud environment. When the biometric recognition succeeds, a unique ID is sent to the cloud environment to trigger downloading of the user's preference data to the vehicle from the cloud environment in the particular region. Any change made to the preference data in the vehicle can be pushed to the cloud environment in the particular region for storage. Additional infotainment applications or driving settings can be suggested by a cloud environment in a particular region when a user in a vehicle enters that region. For one embodiment, the mobile application includes a number of user interfaces that enable a user to access the cloud services.

For one embodiment, any biometrics can be used in this disclosure for user identification. Examples of biometrics can include, but not limited to, facial features, fingerprints, heartbeat patterns.

The embodiments described herein can include non-transitory machine readable media that store executable computer program instructions that can cause one or more data processing systems to perform the one or more methods described herein when the computer program instructions are executed by the one or more data processing systems. The instructions can be stored in non-volatile memory such as flash memory or other forms of memory.

The above description does not include an exhaustive list of all embodiments in this disclosure. All systems and methods can be practiced from all suitable combinations of the various aspects and embodiments described in the disclosure.

The following description and drawings are illustrative and are not to be construed as limiting. Numerous specific details are described to provide a thorough understanding of various embodiments. However, in certain instances, well-known or conventional details are not described in order to provide a concise discussion of embodiments.

The processes depicted in the figures that follow are performed by processing logic that comprises hardware (e.g. circuitry, dedicated logic, etc.), software, or a combination of both. Although the processes are described below in terms of some sequential operations, it should be appreciated that some of the operations described may be performed in a different order. Moreover, some operations may be performed in parallel rather than sequentially.

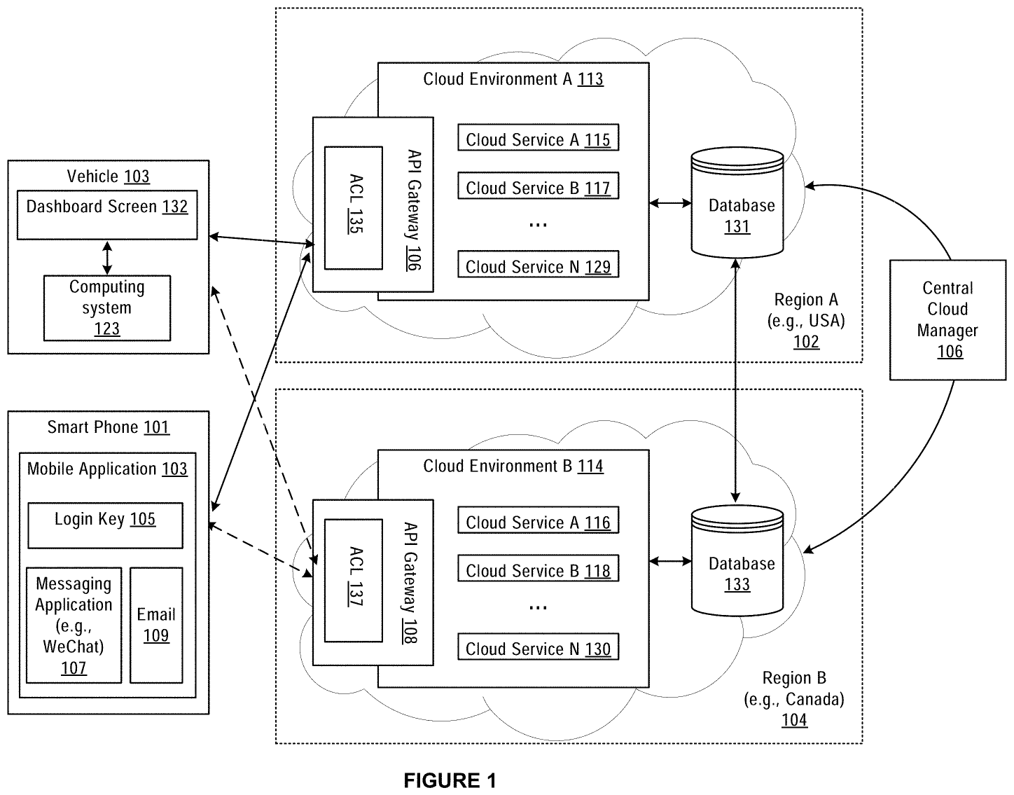

FIG. 1 illustrates a system for correlating services from multiple regions in accordance with an embodiment.

The system can includes a number of cloud environments located in multiple regions, for example, cloud environment A 113 in region A 102 and cloud environment B 114 in region B. Each region can be a country or a group of countries. Each cloud environment can include one or more cloud servers to host a same set of cloud services—for example, cloud services 115, 117 and 129 in cloud environment A 113, and cloud services 116, 118 and 130 in cloud environment B 114. The same set of cloud services can be localized in terms of the services themselves and the contents they provide.

As shown in FIG. 1, a database 131 or 133 can be connected to a cloud environment 113 or 114 in each region. Databases connected to the multiple cloud environments in the system can be synchronized with one another so that a person or a vehicle can access the same set of cloud services in multiple regions. In this example, whenever the database 131 or 133 is updated, any updates can be automatically propagated to the other database through a central cloud manager 106. The central cloud manager 106 can also be used to manage the cloud environments 113 and 114 in each region, including installing and updating cloud services on each cloud environment.

For one embodiment, each cloud environment 113 or 114 can include an API gateway 106 or 108, which represents an interface for authenticating and authorizing requests for cloud services. Each API gateway 106 or 108 can include an access control list (ACL), which includes permissions attached to the cloud services in each cloud environment 113 or 114, and specifies which users or system processes are granted access to the cloud services. Each ACL 135 or 137 can be a data structure containing entries that specify individual user or group tights to specific cloud services.

For one embodiment, a user can first use biometric recognition (e.g., fingerprint or facial recognition) to obtain authentication to drive a vehicle 103 in region A 102. If biometric recognition does not work, that user can use a smart phone 101 to obtain authentication. As shown in FIG. 1, a mobile application 103 on the smart phone 101 can include a login user interface (UI) that allows a user to log in to the cloud environment 113 in region A 102 using a login key 105. The login key 105 can be a unique ID associated with that user and can be created using a predetermined algorithm based a profile of the user. The profile can include that user's name and address. For an alternative embodiment, the mobile application 103 can also include a phone number as the default login, and a messaging application (e.g., WECHAT™) login 107 and an email login 109. The mobile application 103 can associate the email login and the messaging application login with the unique ID created for the user. Similarly, a computing system 123 can associate a user's biometrics (e.g., facial features or voice) with that user's unique ID.

For one embodiment, logging to the cloud environment 113 can trigger a downloading of preference data for the user to a vehicle from the cloud environment 113 in region A 102. The preference data can be retrieved from the database 131 by the cloud environment 113, and can include the user's preferred infotainment applications and driving settings. Examples of infotainment applications can include a map application, a media player, and a video conferencing application. Examples of driving settings can include a temperature, a speed, and a seat recline angle.

When the user drives the vehicle 103 from region A 102 to region B 104, sensors (e.g., GPS) on the vehicle 103 can detect the location change of the vehicle 103, and automatically connect to the cloud environment 114 using the same login credentials that authenticate the person in region A 102. The vehicle 103 can be authenticated to the same cloud services in region B 104 as in Region A 102, and receive the user's desired infotainment applications and driving settings. For one embodiment, the cloud environment 114 in Region B can suggest different infotainment applications and/or driving settings to the user, who can choose to reject or accept.

As an illustrative example, a user can rents a vehicle, obtain the user's preference data from the cloud environment in a region, and get the user's personal preferences set in the rental vehicle. The user can rent any model of a vehicle manufacturer, and have the user's personal preference set in the model, regardless of whether the rental vehicle is a Sedan, SUV, or MPV. Examples of the personal preference data can include driving and seating preferences of drivers or passengers in addition to radio/music genre and other preferences.

For one embodiment, when a user driving a rental vehicle or the user's own vehicle enters a new region, the vehicle can detect that it has entered the new region and pull the user's anonymized data to the cloud environment in the new region, for quick access if the user were to change to a different vehicle again while in the region.

For one embodiment, once the user's vehicle enters the new region, the vehicle can automatically initiate the personal preference data uploading from the vehicle to the cloud service environment in the new region one embodiment without the user to take any action, since the user's profiles and personal preferences have been already loaded in the vehicle that the user is driving.

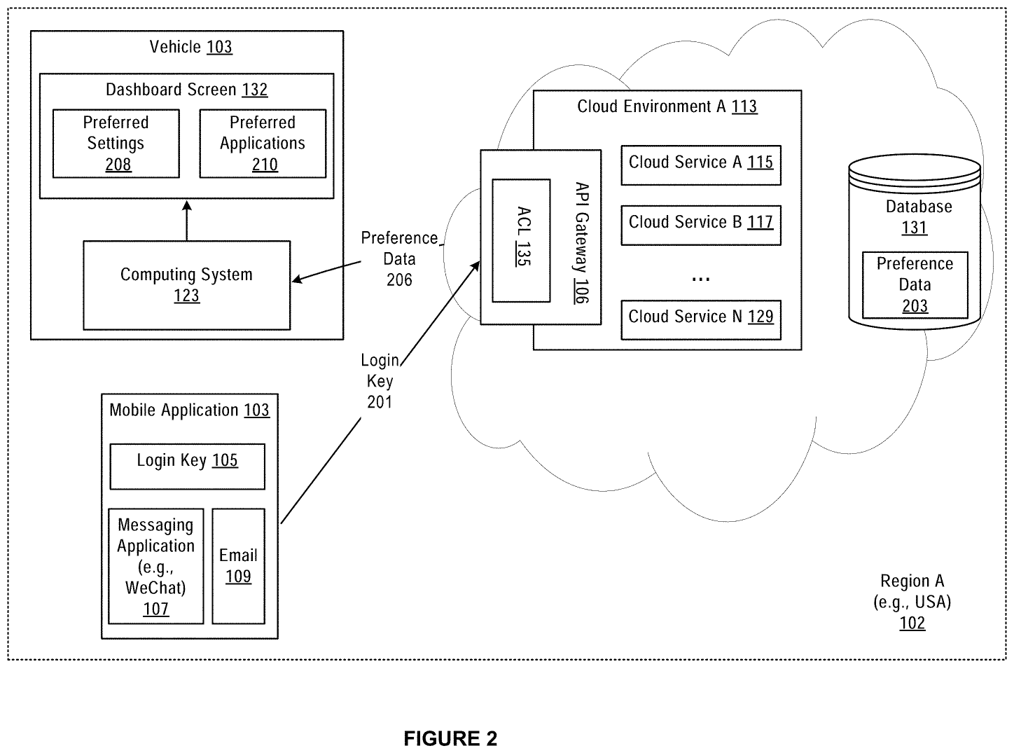

FIG. 2 illustrates another example system for correlating services in accordance with an embodiment. In particular, FIG. 2 illustrates that the vehicle 103 can download preference data 206 from the cloud environment 113 in region A 102 in response to a biometric recognition login or a smart phone login. The cloud environment 113 can retrieve preference data for a particular user using the associated unique ID 201 from a preference data table 203 in the database 131.

For one embodiment, the preference data can specify a user's preferred driving settings 208 and preferred applications 210 that can be displayed on a coast-to-coast dashboard screen 132. The preferred applications 210 can include one or more infotainment applications, such as a media player, a map, a radio station, and a restaurant searching application. The preferred settings 208 can include a user's favorite speed, temperature, personalized user interfaces, personalized seat controls, and personalized steering wheel controls.

For one embodiment, with a unique ID, a driver or a passenger alike can access their preferred applications and driving settings once they are authenticated as identified driver or passenger.

These features allow a person that has registered with the system to travel to multiple regions, and have a vehicle automatically configured with the person's desired applications and driving settings with appropriate authentications.

For one embodiment, a unique ID can be created for a person or a vehicle. For example, if a person has multiple vehicles, each vehicle has its own unique ID registered with the system. Each vehicle can has its own desired applications and settings stored on a cloud environment, and which can be downloaded to the vehicle regardless of the driver. For one embodiment, a driver or a passenger can overwrite part or all of the desired applications and driving settings of a vehicle.

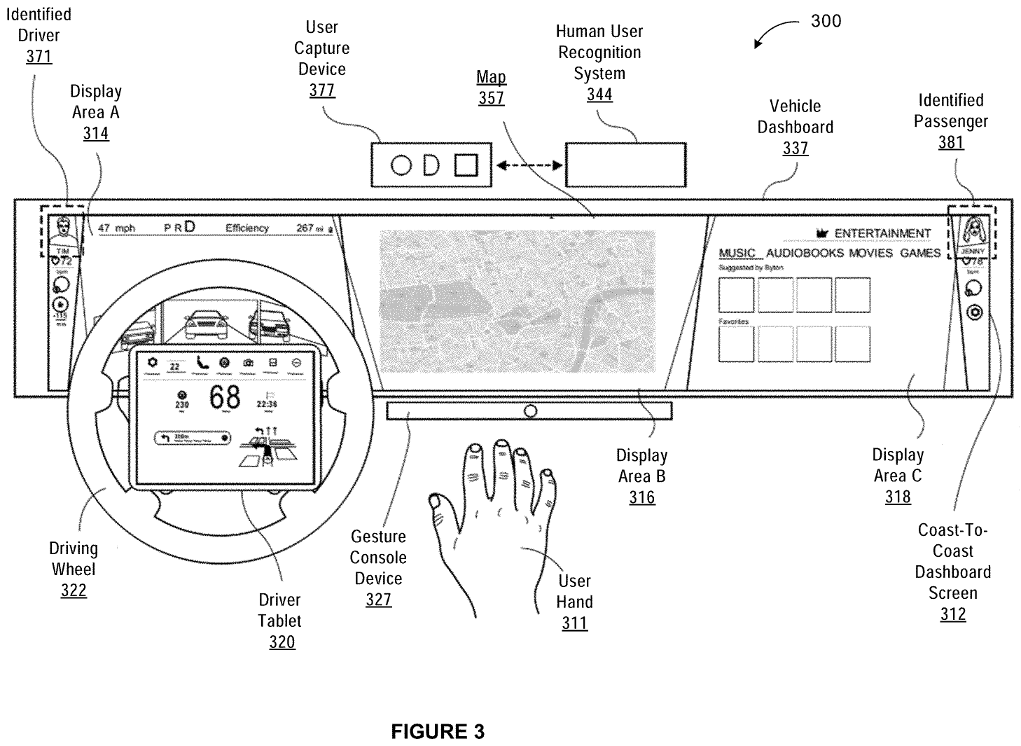

FIG. 3 illustrates an example environment where a user's preference data can be displayed in accordance with an embodiment. As shown in FIG. 3, a control environment 300 includes a dashboard screen 312 (also referred to as a shared-experience display 312 or SED 312) running from one side to the other side of an automobile dashboard 337. The coast-to-coast dashboard screen 312 can be a curved display integrated into and spans the width of the dashboard 337. One or more graphical user interfaces can be provided in a number of display areas, such as display areas A 314, display area B 316, and display area C 318.

Such graphical user interfaces can include status menus shown in, e.g., display areas A 314 and display C 318. For one embodiment, display area A 314 can show driving-critical information, such as instrument clusters, and rear view or side view images of the automobile from one or more cameras located outside or inside of the automobile. For one embodiment, display area B 316 and display area C 318 can display non-driving-critical information. For example, display area B 316 can display a map 357; and display area C 318 can display entertainment settings with preferences for music, audiobooks, movies, and games.

The dashboard 337 can include one more computing devices (not shown) or data processing systems to implement a human user recognition system 344 and to execute the driving-critical and non-driving-critical applications.

For one embodiment, a user capture device 377 can be mounted and located above the dashboard 337 and include a combination of a camera, microphone/speaker and/or fingerprint detector, for use in capturing information (e.g., facial images, voice data and/or fingerprint data of a driver or passenger). The human user recognition system 344 can compare captured user information with pre-stored user signatures to authenticate a user for access to electronic or driving controls of the automobile. The electronic and driving control of the automobile can include interior electronic controls such as interfaces on the dashboard screen 312 and a driver tablet 320 mounted on a driving wheel 322. For example, the driver tablet 320 can provide a driver interface for accessing controls including settings and preferences for the automobile. The coast-to-coast dashboard screen 312 also displays settings and preferences for an identified passenger 381, for example, personalized user interfaces, personalized seat controls, and personalized steering wheel controls.

For one embodiment, a gesture control device 327 mounted below the coast-to-coast display 312 screen can include or more motion cameras and sensors to capture user gestures, e.g., hand gestures of a hand 311 of a user that has properly identified, for use in controlling or accessing applications and functions on the coast-to-coast dashboard screen 312.

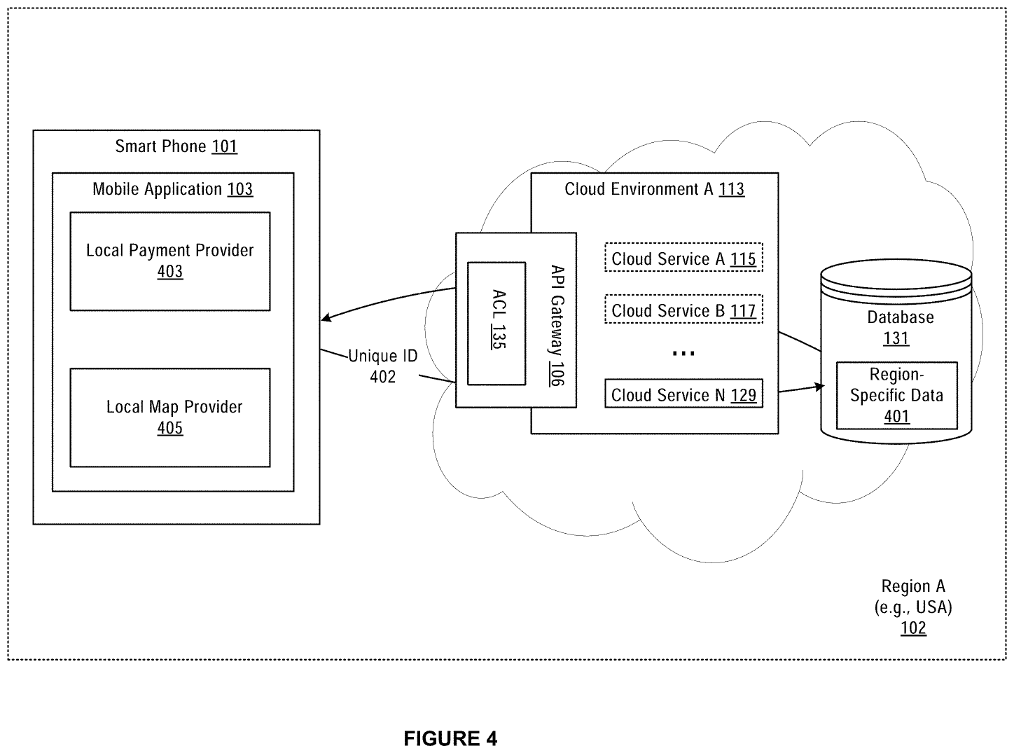

FIG. 4 illustrates another example system for correlating services in accordance with an embodiment. As shown in FIG. 4, a unique ID 402 can be used to access the cloud environment 113 using a smart phone 101 when a holder of the unique ID 402 is located in region A 102. The database 131 can include region-specific data 401 which specifies local service providers.

As such, although a holder of the unique ID 402 can access the same set of cloud services in different regions, the cloud services and contents that the cloud services returned to the mobile application 103 can be localized based on the region-specific data 401 by region. For example, in FIG. 4, a local payment provider 402 and a local map provider 405 can be displayed on the smart phone 101.

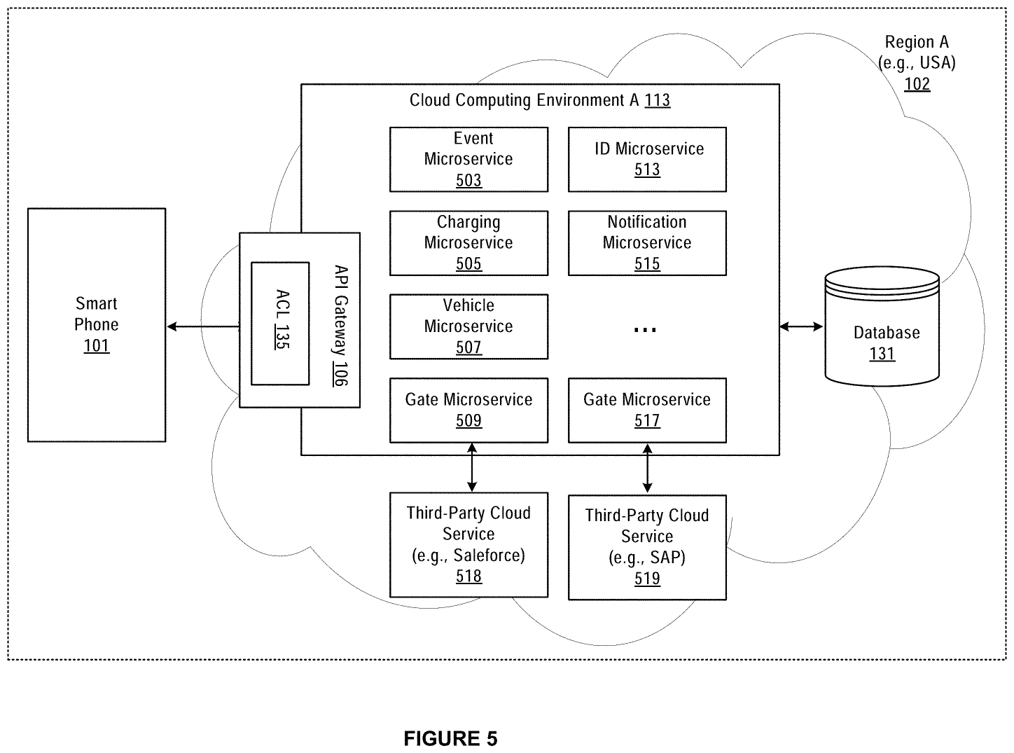

FIG. 5 illustrates example cloud services in a cloud environment in accordance with an embodiment. Referring to FIG. 5, each of the cloud services running in the cloud environment A 113 can be a microservice. The cloud services can include an event microservice 503, a charging microservice 505, a vehicle microservice 507, an ID microservice 513, a notification microservice 515. In addition, cloud environment A 113 can include multiple gate microservices 509 and 517 for connecting to third-parties cloud services 518 and 519.

For one embodiment, the set of microservices 503-517 can be provided in each region, wherein the microservices can be localized based on region-specific data. A user can connect to one or more of the localized microservices in a region where the user is located to enable top performance and compliance with privacy and data regulations.

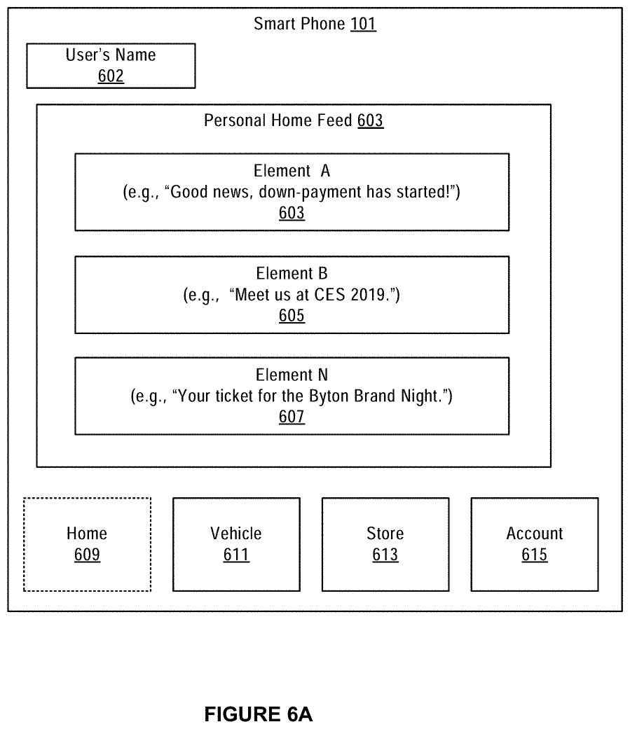

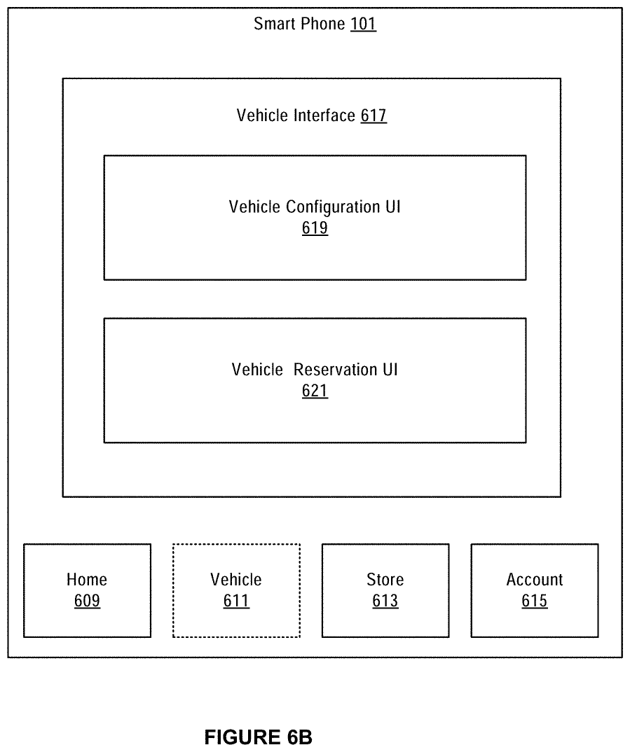

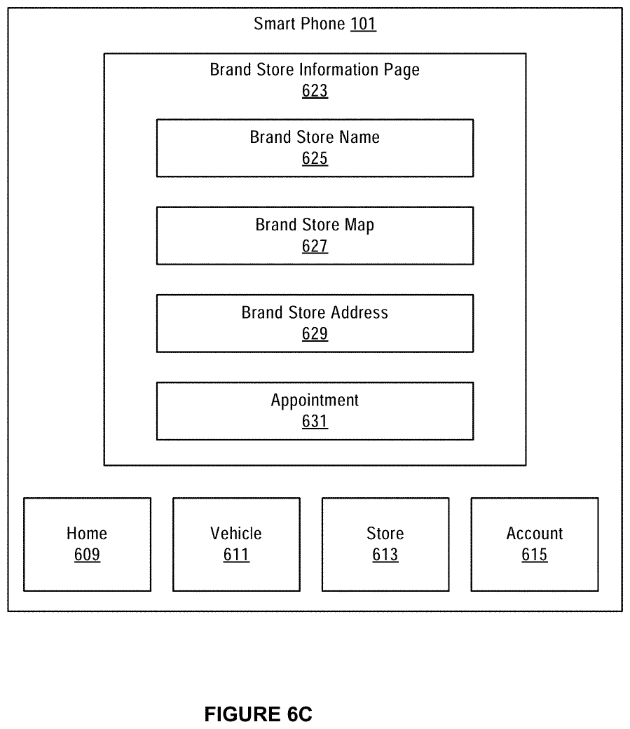

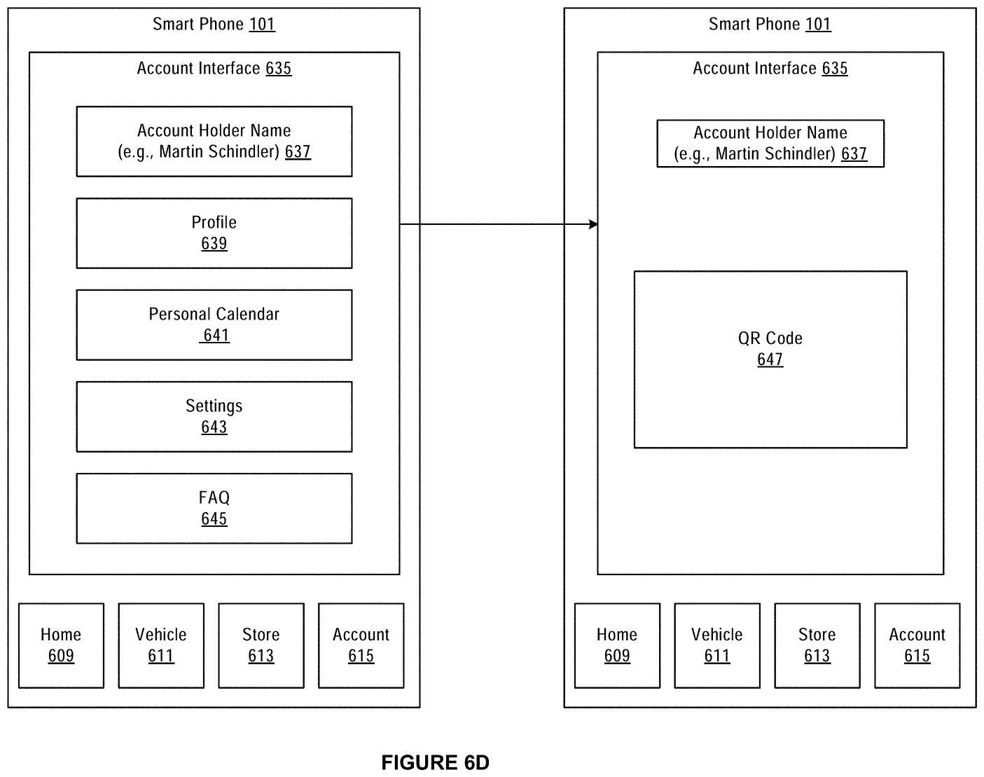

FIGS. 6A-6C illustrate example user interfaces of a mobile application in accordance with an embodiment. FIG. 6A shows a personal home feed interface 603, which can be the landing page of the mobile application 103 in FIG. 4. The personal home feed interface is personalized for each user; the more a user interacts with the smart application, the more personalized the interface 603 will be. The personal home feed interface 603 can be available to guest users (users that are not logged in) but only articles instead of personal news feeds are shown for the guest users. There can be multiple categories of elements (cards) 603, 605 and 607 to show information to a user 602, including articles, events, personal event invitations, and personal notifications. Each card can have a preview with a text and an image. The personal notifications can inform a user of multiple vehicle-related services, for example, and aftersales service suggestions, leasing payments.

For one embodiment, when opened, the content of a card can be based on HTML5 to enable individual styling and embedding of photos, videos and 360° videos. Users can share the content from public cards (articles, public events) via their favorite social media, such as feed items, and write comments under the articles and events.

From the personal home feed interface 603, a user can switch to multiple other interfaces using tabs, for example, a vehicle interface tab 611, a store interface tab 613, and an account interface tab 615. From other interfaces, a user can come back to the personal home feed interface using a “home” tab 609.

FIG. 6B shows an example vehicle interface 617, which can be used to manage a user's vehicle. In this interface, a user can find a model of the vehicle and visualize them in virtual reality (VR) VR/augmented reality (AR), and make a down-payment or a reservation. When a reservation has been placed or a down-payment has been made, the user can view details of the reservation and down-payment. A user can also configure a vehicle using a vehicle configuration UI 619, make a binding order for the configured vehicle, and view details of the reservation using a vehicle reservation UI 621. A user can also follow the status of the reserved vehicle's production. The vehicle interface 617 can also be used to manage a vehicle (e.g., checking status, assigning eligible drivers, managing settings) and use remote services (e.g. locking, locating, and charging)

FIG. 6C illustrates an example store interface to show a brand store information page 623, which can include a brand store name 625, a brand store map 627, a brand store address 629, and an interface 631 for making appointments with a store.

FIG. 6D illustrates an example account interface 635, where a user can access the user's profile 639 and settings 643. When the user is signed up, a name 637 and a picture of the user can be displayed. A personal calendar 641 and a FAQ section 645 can also be displayed on the account interface 635. In the FAQ section 645, a user can find answers to frequently asked questions. A user can generate a personal quick response (QR) code 647 based on the user's profile 639 for authentication and check-in, for example, in a brand store.

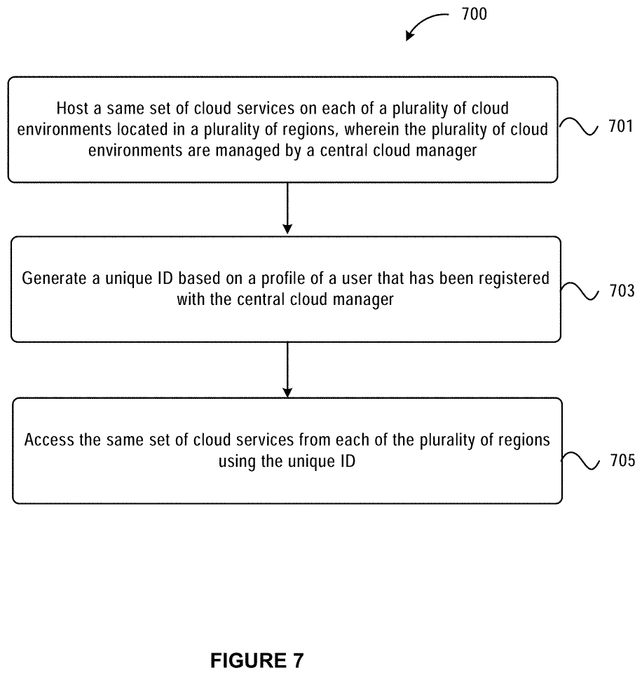

FIG. 7 is a flow diagram of one example method for correlating services across regions in accordance with an embodiment. Method 700 can be performed by hardware (circuitry, dedicated logic, etc.), software (such as is run on a general purpose computer system or a dedicated machine), firmware, or a combination. For example, method 700 can use the system described in FIGS. 1, FIG. 2, FIG. 4, or FIG. 5.

Referring to FIG. 7, in operation 701, a plurality of cloud environments are provided in multiple regions, wherein the plurality of cloud environments are managed by a central cloud manager, and each cloud environment hosts a same set of cloud services. Each cloud environment can include one or more cloud servers. A region can be a country or a group of countries.

In operation 703, a unique ID is generated based on a profile of a user that has been registered with the central cloud manager. The unique ID can be generated using a predetermined algorithm, for example, a Java hashing algorithm. A user can register with the central cloud manager in any region or country by creating a user profile. Since the combination of each field (e.g., first name, last name, address, and zip code) is unique, an ID created based on the user profile would also be unique.

In operation 705, a user can access one or more of the set of cloud services on one of the cloud environments from any of the multiple regions. For example, the user can rent a vehicle from one of the regions, and use biometric recognition in the vehicle or a smart application to log in to a cloud environment in the region. Logging to the cloud environment can trigger a download of the user's preference data to the vehicle. The preference data can include the user's preferred driving settings, for example, a temperature and a seat recline angle; and one or more infotainment applications, for example, the user's favorite album and favorite. The user can be either a driver of the vehicle or a passenger in the vehicle.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality may be implemented in various ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

For one or more exemplary embodiments, the functions described may be implemented in hardware, software, firmware, or any combination thereof. If implemented in software as a computer program product, the functions may be stored on or transmitted over as one or more instructions or code on a non-transitory computer-readable medium. Computer-readable media can include both computer storage media and communication media including any medium that facilitates transfer of a computer program from one place to another. A storage media may be any available media that can be accessed by a computer. By way of example, and not limitation, such non-transitory computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of non-transitory computer-readable media.

The previous description of the disclosed embodiments is provided to enable one to make or use the methods, systems, and apparatus of the present disclosure. Various modifications to these embodiments will be readily apparent, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A system for correlating services, comprising:
a plurality of cloud environments located in a plurality of regions, each of the plurality of cloud environments hosting a same set of cloud services, and the plurality of cloud environments managed by a central cloud manager;
a unique ID based on a profile of a user that has been registered with the central cloud manager;
wherein the unique ID enables access to the same set of cloud services from each of the plurality of regions.

2. The system of claim 1, wherein the plurality of cloud environments are connected to a plurality of configuration databases that are synchronized with one another.

3. The system of claim 1,
wherein each region is a country or a group of countries; and
wherein the unique ID is generated using a predetermined algorithm based on the profile of the user.

4. The system of claim 3, wherein at least one of the same set of cloud services is configured to provide preference data of the user, wherein the preference data specifies one or more infotainment applications and one or more driving settings that the user prefers to use when driving a vehicle.

5. The system of claim 4, wherein the user is to log in to a cloud environment in a particular region using biometric recognition in the vehicle, and if the biometric recognition fails, to use a mobile application and the unique ID to log in to the cloud environment.

6. The system of claim 5, wherein logging to the cloud environment triggers a downloading of the preference data to the vehicle from the cloud environment in the particular region.

7. The system of claim 6, wherein a change made to the preference data in the vehicle is to be pushed to the cloud environment in the particular region.

8. The system of claim 1, wherein additional driving settings and infotainment applications are suggested by a cloud environment in a particular region for the user driving a vehicle as the vehicle enters the particular region.

9. The system of claim 5, wherein the mobile application includes a plurality of user interfaces that enable the user to access the same set of cloud services, which include a news feed service, a vehicle management service, a brand store information service, and an account service.

10. The system of claim 1, where the same set of cloud services and contents they provide are localized by region.

11. A method for correlating services, comprising:
hosting a same set of cloud services on each of a plurality of cloud environments located in a plurality of regions, wherein the plurality of cloud environments are managed by a central cloud manager;
generating a unique ID based on a profile of a user that has been registered with the central cloud manager; and
accessing the same set of cloud services from each of the plurality of regions using the unique ID.

12. The method of claim 11, wherein the plurality of cloud environments are connected to a plurality of configuration databases that are synchronized with one another.

13. The method of claim 11,
wherein each region is a country or a group of countries; and
wherein the unique ID is generated using a predetermined algorithm based on the profile of the user.

14. The method of claim 13, wherein at least one of the same set of cloud services is configured to provide preference data of the user, wherein the preference data specifies one or more infotainment applications and one or more driving settings that the user prefers to use when driving a vehicle.

15. The method of claim 14, wherein the user is to log in to a cloud environment in a particular region using biometric recognition in the vehicle, and if the biometric recognition fails, to use a mobile application and the unique ID to log in to the cloud environment.

16. The method of claim 15, wherein logging to the cloud environment triggers a downloading of the preference data to the vehicle from the cloud environment in the particular region.

17. The method of claim 16, wherein a change made to the preference data in the vehicle is to be pushed to the cloud environment in the particular region.

18. The method of claim 11, wherein additional driving settings and infotainment applications are suggested by a cloud environment in a particular region for the user driving a vehicle as the vehicle enters the particular region.

19. The method of claim 15, wherein the mobile application includes a plurality of user interfaces that enable the user to access the same set of cloud services, which include a news feed service, a vehicle management service, a brand store information service, and an account service.

20. The method of claim 11, where the same set of cloud services and contents they provide are localized by region.

21. A non-transitory machine-readable medium having instructions stored therein, which when executed by a processor, cause the processor to perform operations for correlating services, the operations comprising:
hosting a same set of cloud services on each of a plurality of cloud environments located in a plurality of regions, wherein the plurality of cloud environments are managed by a central cloud manager;
generating a unique ID based on a profile of a user that has been registered with the central cloud manager; and
accessing the same set of cloud services from each of the plurality of regions using the unique ID.
